(19) United States
(12) Patent Application Publication
(10) Pub. No.: US 2009/0026195 A1
(43) Pub. Date: Jan. 29, 2009

(54) Electromagnetic Wave Heating Device

(76) Inventors: Shoji Miyake, Osaka (JP); Tasaburo Saji, Shiga (JP); Toshiyuki Ueno, Shimane (JP)

Correspondence Address: Pearl Cohen Zedek Latzer, LLP, 1500 Broadway, 12th Floor, New York, NY, 10036, US

(21) Appl. No.: 11/886,549

(22) PCT Filed: Mar. 6, 2006
(86) PCT No.: PCT/JP2006/304275

§ 371 Date: Sep. 17, 2007

(30) Foreign Application Priority Data
Mar. 16, 2005 (JP) 2005-076055

(51) Int. Cl. H05B 6/64

(52) U.S. Cl. 219/756

(57) ABSTRACT

This utility model relates to the improvement of the high-frequency heating device providing high-frequency electricity with the box used for the heating-up. The high-frequency electricity was generated by high-frequency oscillator in the high-frequency heating device based on the high-frequency induction heating method.

### BACKGROUND OF THE INVENTION

1. Field of the Invention

The present invention relates to an electromagnetic wave heating device. Especially, the present invention relates to an electromagnetic wave heating device which efficiently transmits electromagnetic wave energy to an object to be heated and has a heat-insulating structure preventing heat emission from the object.

2. Description of the Background Art

In a conventional heating method using an electric furnace and the like, it is necessary to heat the entire electric furnace when heating an object. That necessity causes some problems in the conventional heating method. For example, heating efficiency is low and it takes a long period of time for a heated object to be cooled after the heating. Further, in the conventional heating method, radiation heat is used to heat the surface of an object and thermal conduction is used to transmit thermal energy to the inside of the object to be heated. There is another problem in this conventional heating method. That is, the surface temperature becomes higher than the internal temperature so that a large temperature difference is caused between the surface and the interior of the heated object.

As opposed to this, in an electromagnetic wave heating method, the electromagnetic wave directly vibrates a dipole of a dielectric of an object so that the object itself generates heat. In this heating method, the object to be heated is uniformly heated. In this condition, its inner temperature is higher than its surface temperature due to heat emission from the surface of the object. Hence, it is possible to solve the above-mentioned problems and perform heating treatment that has not been reached in the conventional heating method.

Further, non-thermal effect in the electromagnetic wave heating has been confirmed in a number of research papers (e.g. Non-patent Documents 1 and 2), Japanese Patent Tokkai Publication No. 2000-103608 (Patent Document 1), and the like.

In the conventional electromagnetic wave heating device, a heat insulating structure of housing portion having the object to be heated therein is formed such that; the object is covered with a material which has both high electromagnetic wave transmittance and low thermal conductivity. The heat insulating structure enables the electromagnetic wave energy to reach the object. The object is heated by thermal energy converted from the electromagnetic wave energy. At the same time, heat emission from the heated object is prevented.

However, since the material having both high electromagnetic wave transmittance and low thermal conductivity is used in the heat insulating structure (of the housing portion) in the conventional electromagnetic wave heating device, the acceptable temperature limit goes down in a heat insulating structure. The acceptable temperature limit of Alumina fiber used (in a material for the heat insulating structure) is about 1750° C.

On the other hand, in an invention made by one of the inventors in the present invention, BN (boron nitride) powder is used in a heat insulating member structure of a housing portion. This heat insulating structure may be applicable to less than 2250° C.

However, it is impossible to use this heat insulating member structure under the high-temperature heating at 2250° C. or higher.

Meanwhile, there is a graphite based heat insulating member using carbon fiber or the like for the housing portion that can be applicable to a high temperature of 3000° C. or higher.

However, as the graphite based material is one of the electric conductors, it may not reflect and transmit an electromagnetic wave. That is the problem in using the graphite based material. Therefore, in general, the graphite based material can not be used as the heat insulating material forming the housing portion of the electromagnetic wave heating device.

[Non-patent Document 1]

“Diffusion Controlled Processing in Microwave-fired in Oxide Ceramics”, M. A. Janney, H. D. Kimrey, Materials Research Society Symposium Proceedings vol. 189 (1991), p. 215-227

[Non-patent Document 2]

“Surface Treatment of Metals by Gyrotron Oscillated Millimeter Wave Energy”, Tasaburo Saji, Yukio Makino, Shoji Miyake, Journal of High Temperature Society, Vol. 29, No, 2 (2003), p. 33-36

[Patent Document 1]

Japanese Patent Tokkai Publication No. 2000-103608

### DISCLOSURE OF INVENTION

### Problems of the Invention Aims to Solve

In order to overcome the above described problems, this invention aims to provide an electromagnetic wave heating device which enables to efficiently heat up the object, and has a heat insulating structure. The electromagnetic wave heating device is provided, even when the housing portion which houses the object heated by the electromagnetic wave means, is formed in the material of an electric conductor such as graphite etc. In addition, the present invention provides an electromagnetic wave heating device with a heat-insulating structure preventing heat emission from the object.

### Means to Solve Problems

In the invention described in Claim 1, an electromagnetic wave heating device is provided with a housing portion configured to house an object heated by the electromagnetic wave, an electromagnetic wave irradiation means arranged outside the housing portion, an induction portion configured to guide the electromagnetic wave from the electromagnetic wave irradiation means to the housing portion, wherein the induction portion is arranged outside the housing portion and on the path of the electromagnetic wave from the electromagnetic wave irradiation means, wherein the housing portion has an introduction portion configured to guide the electromagnetic wave from the electromagnetic wave irradiation means to the inside of the housing portion, and wherein the housing portion comprises the carbon fiber.

In the invention described in Claim 4, the electromagnetic wave heating device according to claim 1 is provided, wherein the induction portion is a focusing mirror configured to focus the electromagnetic wave at one point.

In the invention described in Claim 5, the electromagnetic wave heating device according to claim 4 is provided, wherein the focal point of the electromagnetic wave formed by the focusing mirror is positioned inside the aperture portion or between the aperture portion and the object.

In the invention described in Claim 6, the electromagnetic wave heating device according to claim 4 is provided, wherein the shape of the introduction portion is formed along the path of the electromagnetic wave. These inventions totally solve the above-mentioned problems.

### EFFECT OF THE INVENTION

According to the invention described in claim 1, the carbon fiber is used as the housing portion that houses the object in the electromagnetic wave heating device. Therefore, the electromagnetic wave heating device enables to heat up the object in an extremely higher temperature than the acceptable temperature limit in the conventional heating.

According to the invention described in Claim 4, the focusing mirror is formed in the induction portion. Therefore, the electromagnetic wave heating device enables to focus the electromagnetic wave efficiently.

According to the invention described in Claim 5, the positional relation between the induction portion and the housing portion is set so that the focal point of the focusing mirror is positioned between the object and the inside of the introduction portion or the introduction portion. The positioning can provide the electromagnetic wave heating device that enables to decrease the cross-sectional area of the introduction portion.

According to the invention described in Claim 6, the introduction portion is formed along with the width of the passing path for the electromagnetic wave. Therefore, the electromagnetic wave heating device enables to minimize the contact area of introduction portion with the outside air, and to minimize the introduction portion without the electromagnetic wave interruption to the introduction portion.

### DESCRIPTION OF THE PREFERRED EMBODIMENTS

Hereinafter, embodiments of the present invention will be described.

FIG. 1 is a front view of an electromagnetic wave heating device according to the present invention. FIG. 2 is a schematic constitutional view of the electromagnetic wave heating device according to the present invention. FIG. 3 is a cross-sectional view along a line A-A of FIG. 2. FIG. 4 illustrates a relation between a housing portion and a path of an electromagnetic wave.

An electromagnetic wave heating device 1 according to the present invention has electromagnetic wave irradiation means 11, a housing portion 12 and an induction portion 13. The electromagnetic wave irradiation means 11 and the induction portion 13 are arranged outside the housing portion 12. In the arrangement, the induction portion 13 may be provided in contact with the housing portion 12, or provided apart from the housing portion 12.

According to a basic principle of the electromagnetic wave heating device 1, an electromagnetic wave is irradiated by the electromagnetic wave irradiation means 11, and guided to the inside of the housing portion 12 by induction portion 13 so that the electromagnetic wave may heat the object inside the housing portion 12.

In the present invention, it should be noted that any objects can be applicable to the heating as long as users wish to heat. Further, the sizes of the objects are not particularly limited as long as the objects can be housed in a housing portion 12 shown below. It should be also noted that, when the size of the object is set in accordance with an embodiment shown below, the example shape of the object has 10 cm (diameter)×10 cm (height) for its shape.

The electromagnetic wave irradiation means 11 can irradiate a directional electromagnetic wave. The electromagnetic wave irradiated by the electromagnetic wave irradiation means 11 is not particularly limited, but preferably has a frequency in a range of 2 to 300 GHz, more preferably in a range of 18 to 200 GHz.

The housing portion 12 houses an object 2 that is heated by the electromagnetic wave.

The housing portion 12 has a hollow shape, and the object is arranged inside this hollow.

The shape of this housing portion 12 is not particularly limited, but can be appropriately determined by the user. According to one embodiment of the present invention in FIGS. 1 to 3, the housing portion 12 is formed in a cylindrical shape with a bottom.

The size and thickness of this housing portion 12 are not particularly limited, but the housing portion 12 shown in one embodiment has outside dimensions with a diameter about 22 cm and a height about 30 cm, inside dimensions with a diameter about 12 cm and a height about 20 cm, and a heat insulating thickness about 5 cm.

The housing portion 12 has a door portion 121 formed in a door-like shape or a lid-like shape so that the object 2 can be housed therein. The structure of the door portion 121 is not particularly limited, but formed so that the housing portion 12 can be opened and sealed.

In the plan view of the housing portion 12 shown in FIG. 3, the door portion 121 is equipped with opening/closing mechanisms 122 as hinges respectively at its right and left ends, and provided with a grip portion 123 in its front position. This door portion 121 may have the structure of hinged double doors that open right and left. It should be noted that the configuration of this door portion 121 is not limited to the structure of hinged double doors as described above.

The housing portion 12 has an introduction portion 124 that guides the electromagnetic wave irradiated by the electromagnetic wave irradiation means 11 to the inside of the housing portion 12.

The introduction portion 124 forms a path for the electromagnetic wave passing from the electromagnetic wave irradiation means 11 to the inside of the housing portion 12.

As long as the introduction portion 124 is placed on the peripheral surface of the housing portion 12, the introduction portion 124 can be placed anywhere. In the embodiment shown in FIG. 1, the introduction portion 124 is provided on the upper surface of the housing portion 12.

In addition, the introduction portion 124 may be made of a member (material) having both good transmittance of the electromagnetic wave and a low attenuation rate. Further; the introduction portion 124 may be formed as an aperture portion of the housing portion 12 so that the electromagnetic wave can be passed through the housing portion 12.

A material having a low attenuation rate described above is preferably used as the material of the introduction portion 124. In one example, metal tungsten can be used as the material of the introduction portion 124.

When the material as above is used in the introduction portion 124 from the viewpoint of the thermal conductivity problem, it is preferable that only the surface is formed in the material.

Moreover, the introduction portion 124 can be formed as an aperture portion that extends the housing portion 124 along its thickness direction, and in this case, the electromagnetic wave passes through the air (air inside the aperture portion).

Additionally, in the embodiment shown in the figure, the introduction portion 124 is formed as the aperture portion extending the housing portion 12 in its thickness direction.

The shape of this introduction portion 124 is not particularly limited, but preferably is the same shape as that of the path of the electromagnetic wave as described above.

For example, FIG. 4 illustrates the relation between the shape of the introduction portion 124 in the housing portion 12 and the path of an electromagnetic wave. In FIG. 4A, an upper portion 1241 of the introduction portion 124 is formed to have a taper shape gradually narrowing downward. In FIG. 4B, the upper portion 1241 is formed to have a taper shape gradually narrowing downward, a middle portion 1242 is formed to have a straight path, and a lower portion 1243 is formed to have a taper shape gradually spreading downward. In FIG. 4C, the upper portion 1241 is formed to have a taper shape gradually narrowing downward, and the lower portion 1243 is formed to have a taper shape gradually spreading downward.

The above-mentioned shape of the introduction portion 124 can extremely decrease a contact area of the housing portion 12 with the external air. Particularly in FIG. 4C, as the introduction portion 124 has an area slightly larger than a portion of a focal point of the electromagnetic wave, the contact area with the external air can be minimized. Therefore, it is possible to extremely reduce the heat discharged to the external air.

Regarding the size in the embodiment shown in FIG. 4B, the aperture diameter at the surface of the introduction portion is configured from 2.0 cmφ to 10.0 cmφ preferably from 3.0 cmφ to 5.0 cmφ), the aperture diameter at the focal point of the electromagnetic wave is configured from 1.0 cmφ to 5.0 cmφ (preferably from 1.5 cmφ to 2.0 cmφ), the aperture diameter at the inner surface in the introduction portion is configured from 1.0 cmφ to 5.0 cmφ (preferably from 1.5 cmφ to 3.0 cmφ). The introduction portion 124 is formed to have a shape conically narrowing downward (from the entrance to the half of the thickness), a cylindrical aperture continues thereafter to a quarter of the thickness, and the remaining quarter portion again conically spreads downward.

In addition, the present invention is not limited to this size, and this size is applicable to the embodiments shown in FIG. 4A as well as FIG. 4C.

As the object 2 is housed in the housing portion 12 and heated therein, a material having both heat resistance and a heat insulating property is used for the housing portion 12.

As the housing portion 12 has the introduction portion 124 as described above, an electromagnetic wave is guided into the housing portion 12 without interrupting the housing portion 12. An electric conductor can be used as a material for the housing portion 12.

Here, in the present invention, a carbon fiber is used for the material (an electric conductor) of the housing portion (12). This will enable to form the housing portion (12) having an excellent heat insulating. Accordingly, the housing portion (12) may be applicable to the extremely high heating temperature (about 3000° C. as described above), while the object is heated by the electromagnetic wave.

The induction portion 13 is arranged on the path of the electromagnetic wave from the electromagnetic wave irradiation means 11. The induction portion 13 guides the electromagnetic wave from the electromagnetic wave irradiation means 11 into the housing portion 12.

This induction portion 13 may guide the electromagnetic wave to the housing portion 12. Preferably, this induction portion 13 may have a focusing mirror having a bowl-shaped reflection portion to make the electromagnetic wave focus to one point.

The focusing mirror used for the induction portion 13 enables to focus and guide the electromagnetic wave to the housing portion 12 so that the area of the introduction portion 124 as described above can be reduced.

The shape of this focusing mirror is not particularly limited, but the focusing mirror is formed to have a parabolic mirror without a spherical aberration and the like, and has high focusing performance.

It should be noted that the focusing mirror has 15.0 to 80.0 cmφ in a diameter for its feature, and the parabolic mirror has a focal length of 10 cm to 100 cm. Further, a material having high electric conductivity, or a material having high electromagnetic wave reflectivity, is preferably used as a material of the focusing mirror. For example, the focusing mirror is preferably made from aluminum or copper which results in small loss of the electromagnetic wave on the reflection face.

In addition, a column supporting the induction portion 13 is not shown in the figure, but the induction portion 13 is installed on an independent column. For example, when the electromagnetic wave goes from an upper side to the housing portion 12 in the embodiment shown in the figure, the induction portion 12 can be firmly fixed by using a structure that supports the housing portion 12 as well as the independent column. This facilitates the electromagnetic wave irradiation to the object 2.

As described above, the introduction portion 124 provided in the housing portion 12 and the induction portion 13 may be arranged so that the electromagnetic wave from the electromagnetic wave irradiation means 11 is irradiated to the object in the housing portion 12 via the induction portion 13. And, the positional relation between the induction portion 13 and the introduction portion 124 provided in the housing portion 12 is not particularly limited. In the embodiment according to the present invention, the introduction portion 124 and the induction portion 13 are positioned so that the electromagnetic wave from the induction portion 13 is irradiated from above in the vertical direction with respect to the housing portion 12.

As the induction portion 13 reflects and focuses the electromagnetic wave and guides it to the housing portion 12, the introduction portion 124 as described above is formed in a taper shape. In this case, it is preferable to arrange the housing portion 12 and the induction portion 13 so that the induction portion 13 forms the focus of the electromagnetic wave inside the introduction portion 124 or between the introduction portion 124 and the object 2.

The above-mentioned arrangement of the housing portion 12 and the induction portion 13 ensures to extremely decrease the contact area of the inside of the housing portion 12 with the outside air.

It has been impossible to heat a ceramic-molded object etc. to 2300° C. or higher (e.g. 3000° C.), even when graphite material or the like having high heat resistant performance is used as a heat insulating member. That is because millimeter wave etc. used in the heating is reflected on the surface (as it is an electric conductor).

However, according to the present invention shown in FIGS. 1 to 3, the induction portion 13, or the focusing mirror focuses and reflects the electromagnetic wave so that a focused electromagnetic wave is obtained. The focused electromagnetic wave enables to heat up the object to a high temperature close to 3000° C.

Moreover, as the introduction portion 124 in a housing portion 12 partially has a taper shape and is formed along the path of the electromagnetic wave, the electromagnetic wave does not interrupt with the housing portion. Therefore it is possible to form the housing portion 12 with an electric conductor; thereby allows the object to be heated even at an extremely high temperature.

Furthermore, as the induction portion 124 has a taper shape along the path of the electromagnetic wave, it is possible to extremely decrease the contact area of the inside of the housing portion 12 with the outside air. It is therefore possible to form the housing portion 12 having an extremely excellent heat insulating effect.

### INDUSTRIAL APPLICABILITY

The present invention relates to a device for the efficient heating using electromagnetic waves such as a millimeter wave. In the present invention, the electromagnetic waves such as a millimeter wave can heat a molded object made from heat resistant powder, for example ceramic powder, which extremely has high temperature, and a material that requires high temperature heating, for example functional carbon.

The present invention is applicable to industries that engage in creating new materials, such as creation or surface modification of high functional ceramics by heat sintering.

### BRIEF DESCRIPTION OF THE DRAWINGS

FIG. 1 is a front view of an electromagnetic wave heating device according to the present invention.

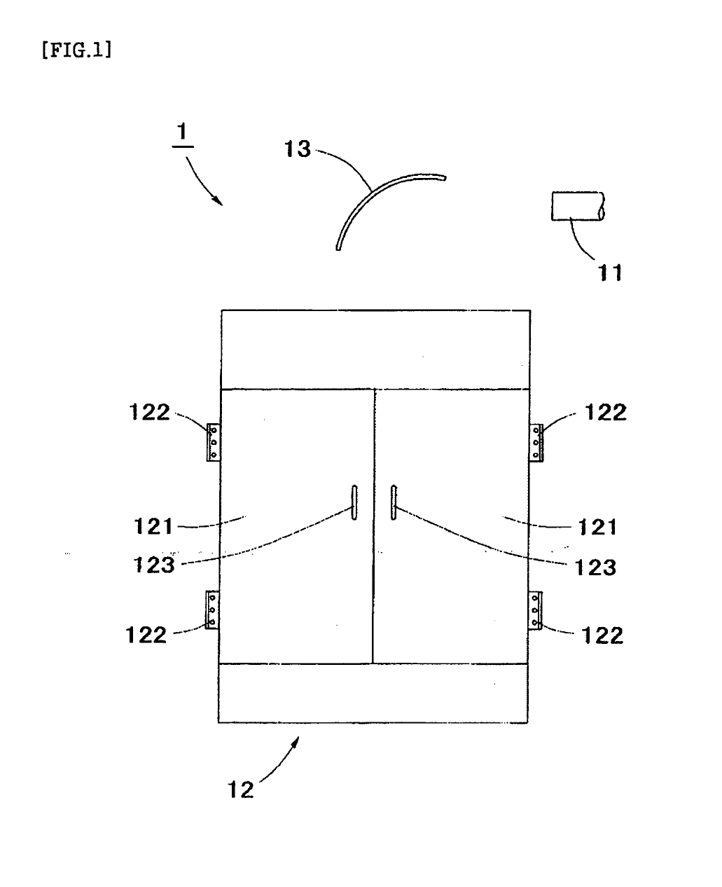

FIG. 2 is a schematic constitutional view of the electromagnetic wave heating device according to the present invention.

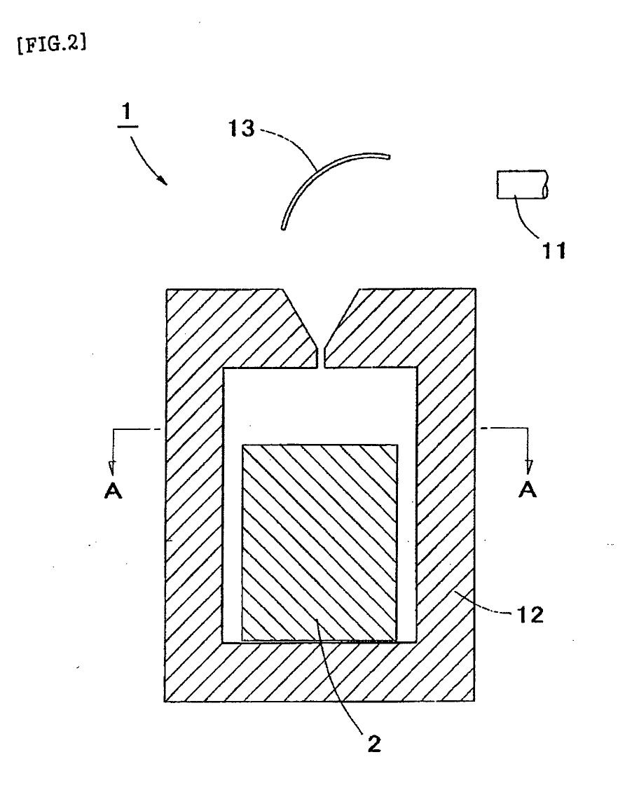

FIG. 3 is a cross-sectional view along a line A-A of FIG. 2.

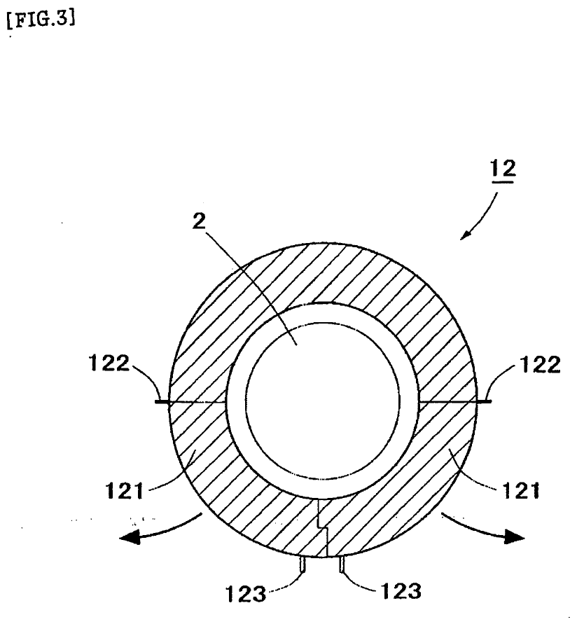

FIG. 4 illustrates a relation between a housing portion and a path of an electromagnetic wave.

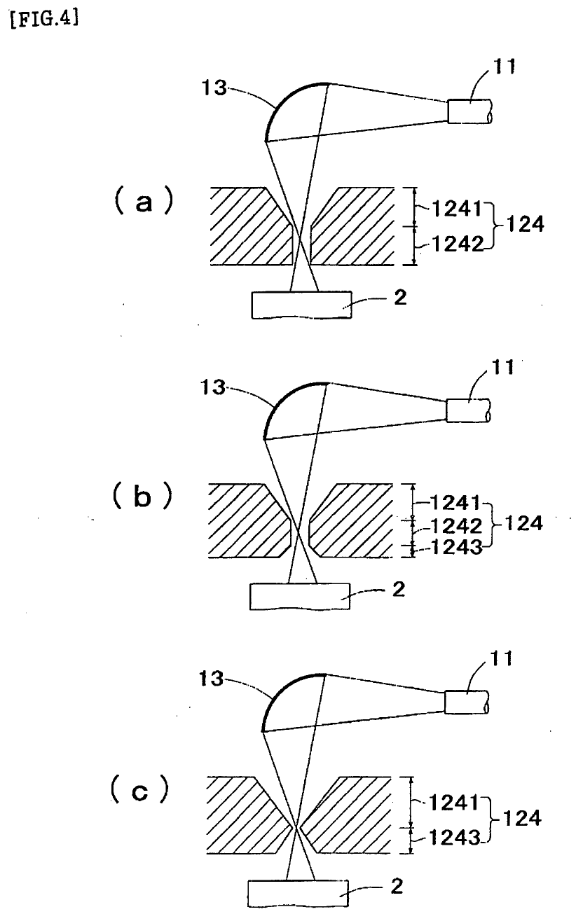

### EXPLANATION OF REFERENCE NUMERALS

1 electromagnetic wave heating device
11 electromagnetic wave irradiation means
12 housing portion
124 introduction portion
13 induction portion

1-6. (canceled)

7. An electromagnetic wave heating device comprising:
a housing portion configured to house an object heated by the electromagnetic wave;
an electromagnetic wave irradiation means arranged outside the housing portion;
an induction portion configured to guide the electromagnetic wave from the electromagnetic wave irradiation means to the housing portion;
wherein the induction portion is arranged outside the housing portion and on the path of the electromagnetic wave from the electromagnetic wave irradiation means,
wherein the housing portion has an introduction portion configured to guide the electromagnetic wave from the electromagnetic wave irradiation means to the inside of the housing portion, and
wherein the housing portion comprises carbon fiber.

8. The electromagnetic wave heating device according to claim 7, wherein the induction portion is a focusing mirror configured to focus the electromagnetic wave at one point.

9. The electromagnetic wave heating device according to claim 8, wherein the focal point of the electromagnetic wave formed by the focusing mirror is positioned inside the introduction portion.

10. The electromagnetic wave heating device according to claim 8, wherein the focal point of the electromagnetic wave formed by the focusing mirror is positioned between the introduction portion and the object

11. The electromagnetic wave heating device according to claim 8, wherein the shape of the introduction portion is formed along the path of the electromagnetic wave.
